(19) United States
(12) Patent Application Publication
(10) Pub. No.: US 2004/0039790 A1
(43) Pub. Date: Feb. 26, 2004

(54) Museum system utilizing the internet network

(76) Inventor: Jaa-Hak Lee, Kyunggi-do (KR)

Correspondence Address: Frank Chau, F Chau & Associates, Suite 501, 1900 Hempstead Turnpike, East Meadow, NY, 11554, US

(21) Appl. No.: 10/380,607

(22) PCT Filed: Sep. 14, 2001
(86) PCT No.: PCT/KR01/01546

(30) Foreign Application Priority Data
Sep. 15, 2000 (KR) 2000/54256

(51) Int. Cl. G06F 15/16

(52) U.S. Cl. 709/217

(57) ABSTRACT

The present invention relates to an Internet-based museum system, in which a detailed personal history is stored into a data bank in the form of digital data; an operator continually updates the personal data including genetic information for a predetermined period, recognizes users or descendants of the users allowing them to confirm or inspect the data accumulated in the data bank, carries out management of the users, manufactures glittering ashes-containing molds into special shapes by mixing the ashes with specific ingredients when the users die, manages the molds installed in an exhibition hall, and allows the descendants to inspect information about the deceased or be provided with the data at a specific date, so that management of the ashes is simplified while all kinds of personal information is readily inspected or obtained, and people can inspect the data or information without visiting the museum or the exhibition hall and see or purchase articles without visiting shops or stores.

### TECHNICAL FIELD

The present invention relates generally to personal and commercial Internet-based museum systems for exhibition, and more particularly to an Internet-based museum system, in which a detailed personal history is stored into a data bank in the form of digital data, an operator continually updates the personal data including genetic information for a predetermined period, recognizes users or descendants of the users allowing them to confirm or inspect the data accumulated in the data bank, carries out management of the users, manufactures glittering ashes-containing molds into special shapes by mixing the ashes with specific ingredients when the users die, manages the molds installed in an exhibition hall, and allows the descendants to inspect information about the deceased or be provided with the data at a specific date; and articles displayed in shops, museums and exhibitions are three-dimensionally photographed or cameras are mounted so that the displayed articles can be viewed via the Internet without visiting exhibition halls.

### Background Art

The Internet has been expanded more rapidly than expected. The number of Internet sites is doubling every four months, since not only enterprises but also individuals are creating their own home pages for public relations. Many people are expressing their interest in the home pages across many fields including art, literature, science, medical science, entertainment, sports, politics, technology, industry and economics. Worldwide news articles with various contents from gossip to specialized subjects are dealt with by news groups that are organized by people interested in specific fields.

In the meantime, as the Internet and digital technologies are rapidly spreading, not only processing of information, data and materials but also publication is carried out via the Internet in digital format.

Autobiographies are also being edited through electronic publishing according to such a trend, however, such data may not coincide with facts and frequently composed of text and photographs only. Further, such data are not managed systemically.

Further, although people own a great quantity of records via many media such as photographs, videocassettes, audiocassettes and the like, they hardly listen to or view the records. Therefore, almost all of those records are kept in dead storage when owners thereof pass away.

In particular, there are limitations in that a person composes data of him/herself or his/her ancestors into a data bank in order to see or show the data to descendants, or even offer such information to the public.

In other words, since it is not easy at all to compose the data or manage the data by him/herself, the data may be so composed to be opened only to him/her or specific people, and it is costly to manufacture or maintain the data with quality of at least a certain level, general people can rarely make records about themselves.

In the meantime, since dead bodies are buried or laid in mausoleums after cremation according to funeral cultures in the Confucian or Buddhist societies, the remains of the dead may be concealed, management thereof consumes a large amount of money, many people may be reluctant to visit such places due to dislikes, and management of the ashes consumes a great amount of labor and money.

Meanwhile, up to the present, in order to display articles, view exhibition halls and exhibited articles, and purchasing exhibited articles, people have to personally visit the shops or the exhibition halls such as museums.

### Disclosure of the Invention

Accordingly, the present invention has been made keeping in mind the above and other problems of the prior art, and an object of the invention is to provide an Internet-based museum system which stores the detailed personal history of a person into a data bank in the form of digital data so that the person in question, his/her descendants and even general people have access to the data of the person.

Another object of the present invention is to provide an Internet-based museum system which has an exhibition hall and is associated with both of a data bank and an operator server so that people can view ashes-containing molds of the deceased by visiting the exhibition hall or via the Internet, data of specific persons are opened to the public, ashes are easily managed and the exhibition hall has an aesthetic appearance to prevent the people from feeling dislikes.

Still another object of the present invention is to provide an internet-based museum system which performs remote management by employing a live picture technique or mounting cameras so that people can see vivid on-the-spot images or purchase articles while viewing such images, in which buildings of various exhibition halls including a museum are photographed in an actual form along gates up to the exhibition halls so that the people can sufficiently see the exhibition halls in a cyber-space without personally visiting the exhibition hall

In order to accomplish the above objects, according to an aspect of the present invention, a detailed personal history is stored into a data bank in the form of digital data, and an operator continually updates the personal data for a predetermined period, recognizes users or descendants of the users allowing them to confirm or inspect the data accumulated in the data bank, carries out management of the users, manufactures glittering ashes-containing molds into special shapes by mixing the ashes with specific ingredients when the users die, manages the molds installed in an exhibition hall, and allows the descendants to inspect information about the deceased or be provided with the data at a specific date, thereby simplifying management of the ashes and allowing all kinds of personal information to be readily inspected or obtained.

### BRIEF DESCRIPTION OF THE DRAWINGS

FIG. 1 is a schematic diagram illustrating a system in accordance with the invention; and

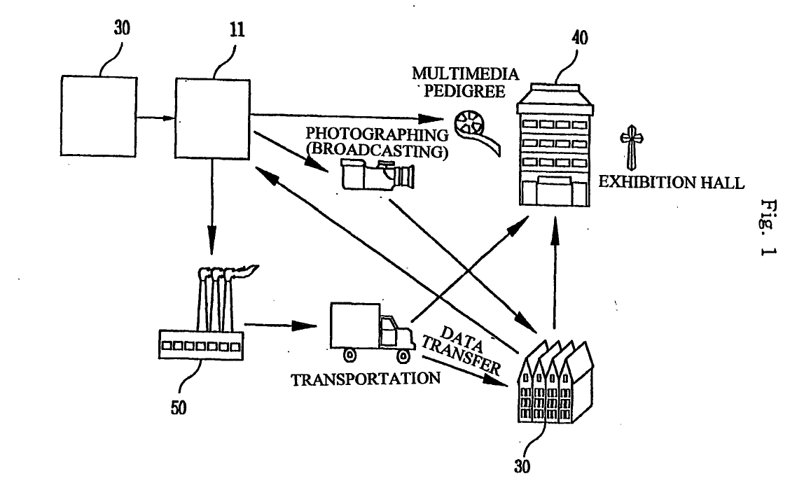

FIG. 2 is a schematic view illustrating the configuration of the invention.

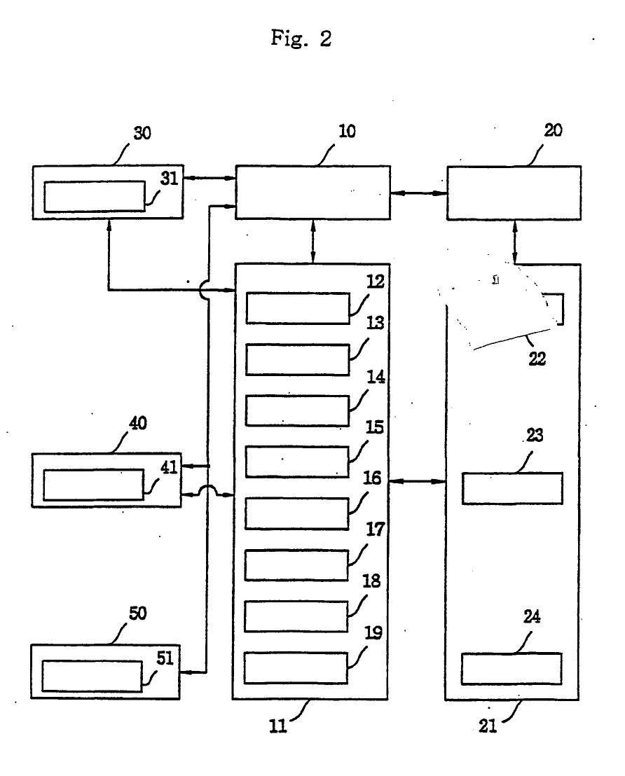

<Description of reference characters of important parts>

| | |
|---|---|
| 10: operator | 20: data bank |
| 30: user | 40: exhibition hail manager |
| 50: manufacturer of ashes-containing mold | |

### BEST MODE FOR CARRYING OUT THE INVENTION

The present invention will be described in more detail with reference to the accompanying drawings as follows.

A personal Internet-based museum system in accordance with the invention is comprised of an operator server 11 managed by an operator 10 and comprised of a member management system 12 having a means for allowing membership registration for the purpose of using the system, assisting members to maintain membership and providing the members with various information, an electronic key system 13 for discriminating the members from general people to allow exclusive access to the members, a personal information management system 14 for digitalizing and periodically updating membership information into a data bank 21, an information transfer processing system 15 for establishing a platform to transfer digitalized information into various forms of communication media such as telephones, facsimiles, mobile telephones, Personal Communications Services (PCS) devices, Internets and personal computer networks, a management system 16 of an exhibition ball 40, an information transfer system 17 of the exhibition hall 40, a management system 18 of an ashes-containing mold manufacturer 50; a data bank 21 which is managed by a data bank manager 20 and constituted of an electronic key system 22 for allowing exclusive access to the members, a database 23 storing detailed personal history and an information transfer system 24 for transmitting information into the operator server 11; a user terminal 31 for transferring all of the personal specifications into the operator 10, accessing the operator server 11 and receiving information from the data bank 21 and receiving various information from the operator; a terminal 41 of the exhibition hall 40 for displaying ashes-containing molds of the dead, managing visitors and having a security device and means for displaying information received from the data bank 21 via various media; a terminal 51 of the ashes-containing mold manufacturer 50 used to receive ashes and manufacture the ashes into a special shape to manufacture the ashes-containing mold.

The operator server 11 includes an information data input/output device 19 for inputting/outputting information from the members and various information of the data bank 21 so as to input audio messages, text messages and various information data into users and output information provided by the users, in which the information data input/output device 19 may be communication means or a computer of the operator.

When a person inputs personal information, a method of membership fee payment, a means for receiving information and a desired grade of membership, the member management system 12 issues him/her an unique ID and a unique password, and continually confirms membership fee payment to allow membership to him/her or deprive him/her of membership.

The member management system 12 informs a person designated to succeed the membership according to a predetermined contract when a member dies, determines membership grade to confirm the member according to the grade, and regulates information to be provided.

The electronic key system 13 authenticates the members or establishes kinds and limitations of information to be provided when the members and the general people access the data bank 21 to have access to specific information, and prevents the general people connected to the data bank 21 from damaging various information stored therein.

The electronic key system 13 is interlocked with the electronic key system 22 of the data bank 21 to allow specific information to be inspected or provided only if a pre-inputted password is identified, and allow specific information to be inspected or provided only if the operator 10, the data bank manger 20 and a user 30 have the same password, in which the operator 10, the data bank manager 20 and the user 30 may change the password by mutual agreement.

The personal information management system 14 digitalizes various information provided from the members, and stores digital information into the data bank 21 by grading the same at the request of the members or based upon judgment of the operator 10.

In other words, the user 30 or member provides the operator 10 with various information such as photographs, audiocassettes, videocassettes, digital data obtained from digital cameras, favorite collections, and various documents such as diaries, writings and autobiographies, When the user 30 or member dies, the operator receives various information as above from descendants of the user or member, converts the various information into digital data, and then stores the digital data into the database 23 of the data bank 21.

The information transfer processing system 15 functioning to provide various data transmitted from the data bank 21 to the user 30 establishes a platform for transferring the data into various communication media such as telephones, facsimiles, mobile telephones, PCS devices and Internet and PC networks, and transmits the data into receiving means previously designated by the user 30.

The exhibition hall management system 16 is constructed for maintaining the exhibition hall 40 without damage. The exhibition hall management system 16 controls temperature, humidity and the like within the exhibition hall 40 at the optimal conditions, and regulates visitors as well as prevents the visitors from damaging the exhibition hall.

The exhibition hall information transfer system 17 provides various data about the current conditions via various communication media at the request of the user 30 in order to confirm that the ashes-containing mold is carefully preserved without damage, and allows various data to be provided from the user 30, member or his/her descendants.

The management system 18 for the ashes-containing mold manufacturer manages the ashes-containing mold manufacturer which cremates the dead body under the contract with the user 30 or member or at the request of his/her descendants when the user or member dies, and mixes the ashes with specific chemical ingredients to form into an aesthetic pearl shape. The ashes-containing mold manufacturer 50 carries out all funeral procedures from laying and cremating the dead body up to burial in place of the descendants when the user 30 or member dies, and ensures thorough management and security to prevent damage to the dead body or ashes while improving convenience.

The information data input/output device 19 is a system such as a terminal of the operator 10 for inputting information provided from the user 30 and outputting inputted data for correction or supplementation thereof.

The data bank 21 is managed by the data bank manager 20, and is comprised of the electronic key system 22, the database 23, the information transfer system 24 and the like.

The data bank 21 can be directly managed by the operator 10. However, in order to ensure reliable security and prevent information damage, it is preferred to establish a separate server in the data bank manager 20 of a separate service provider, preferably a bank.

The electronic key system 22 is interlocked with the electronic key system 13 of the operator server 11 to allow specific information to be inspected or provided only if a pre-inputted password is identified, and allow specific information to be inspected or provided only if the operator 10, the data bank manger 20 and a user 30 have the same password, in which the password may be changed by mutual agreement among the operator 10, the data bank manager 20 and the user 30.

Each of the electronic key systems 13 and 22 is individually constructed in each of the operator server 11 and the data bank 21 so as to ensure security while preventing free leakage or damage of data.

The database 23 grades various pieces of information digitalized by the personal information management system 14 and the information data input/output device of the operator server 11, and stores graded information therein so as to provide the stored data to the general people according to the grade of information.

In other words, the database 23 stores information according to grade so that uncontrolled information may be provided to general netizens via the operator server 11 while controlled information such as private data or testaments can be provided only to family or specified persons.

The information transfer system 24 functions to transfer information extracted from the database 23 at the request of the user 30 or member into the operator server 11, and is associated with the electronic key system 22 to authenticate the user 30 and confirm the range of providing information so that information can be provided only in the specific range.

The operation of the inventive system constructed as above will be described in more detail as follows.

To start with, the operator 10 establishes the operator server 11 that is comprised of the membership management system 13, the electronic key system 13, the personal information management system 14, the information transfer processing system 15, the exhibition hall management system 16, the exhibition hall information transfer system 17, the management system 18 of the ashes-containing mold manufacturer and the information data input/output device 19; builds the exhibition hall 40; associates with the data bank manager 20 and the ashes-containing mold manufacturer 50 to ensure that the ashes-containing molds can be made at any time; and instructs the data bank to comprise the electronic key system 22, the database 23, the information transfer processing system 24 and the like, thereby establishing a close organic relationship with the data bank manager 20, the exhibition hall 40 and the ashes-containing mold manufacturer 50.

Then, the operator 10 recruits members, receives various information or data such as photographs, audio cassettes, video cassettes, digital data obtained from digital cameras, favorite collections, and various documents such as diaries, writings and autobiographies from the recruited members, converts the various data into digital data, and stores the digital data into the database 23 of the data bank 21 by grading the same at the request of the members 30 or based upon judgment of the operator 10.

In this case, the electronic key systems 13 and 22 are operated between the operator 10 and the data bank manager 20 to prevent anyone from accessing the data bank 21 except for the operator so that the damage of information and the leakage of secrets can be prevented.

In the meantime, when the member dies or the member wants to move the exhumed body of his/her ancestor into the exhibition hall 40, the descendants or the member may inform the operator by wire/radio or via the member management system 12 so that the operator 10 carries out all funeral procedures in place of the descendants or member at the request of them, as well as cremates the dead body and lays an ashes-containing mold which is manufactured by the ashes-containing mold manufacturer 50 into the exhibition hall 40, in which the laid mold is constantly monitored to be observed by the member, the descendants of the member and other people also.

As constructed above, the general user 30 may access the operator server 11 to receive general information therefrom.

In particular, at the anniversary of the deceased with his/her information stored in the data bank 21, descendants may access the operator server 11 to receive multimedia or even holographic images and information of the deceased from the data bank 21 as they are seated for a religious service and clearly see the lifetime images of the deceased via various media. The descendants can confirm the images of the ancestor and come to know detailed specifications related to their birth.

Moreover, the general people may easily obtain information of a specific person. Further, if data of a number of people is stored, data of a person may be sufficiently obtained without any other historical investigation.

### Industrial Applicability

As described above, according to the present invention, a detailed personal history is stored into a data bank in the form of digital data; an operator continually updates the personal data including genetic information for a predetermined period, recognizes users or descendants of the users allowing them to confirm or inspect the data accumulated in the data bank, carries out management of the users, manufactures glittering ashes-containing molds into special shapes by mixing the ashes with specific ingredients when the users die, manages the molds installed in an exhibition hall, and allows the descendants to inspect information about the deceased or be provided with the data at a specific date, so that management of the ashes is simplified while all kinds of personal information is readily inspected or obtained, and people can inspect the data or information without visiting the museum or the exhibition hall and see or purchase articles without visiting shops or stores.

1. An Internet-based museum system, comprising:
an operator server 11 managed by an operator 10 and comprising a member management system 12, an electronic key system 13, a personal information management system 14, an information transfer processing system 15, a management system 16 of an exhibition hall 40, an information transfer system 17 of the exhibition hall 40 and a management system 18 of an ashes-containing mold manufacturer 50;
a data bank 21 managed by a data bank manager 20 and comprising an electronic key system 22, a database 23, and an information transfer processing system 24;
a user terminal 31 for transferring all specific information of a user into the operator 10, accessing the operator server 11 and receiving information from the data bank 21, and receiving various information from the operator;
a terminal 41 in the exhibition hall 40 displaying ashes-containing molds of the deceased, having means for receiving information from the data bank 21 and displaying the received information via various media, regulating visitors, and having a securing device; and
a terminal 51 of the ashes-containing mold manufacturer 50 used to receive ashes and manufacture the ashes into a special shape to manufacture the ashes-contaning mold.

2. The Internet-based museum system in accordance with claim 1, wherein said member management system 12 issues an ID and a password unique to a member when a person inputs personal information, a policy of membership fee payment and means for receiving information and membership grade, and continually confirms membership fee payment to continuously allow him/her with the membership or deprive him/her of the membership.

3. The Internet-based museum system in accordance with claim 1, wherein the electronic key system 13 authenticate members or establishes kinds and limitations of information to be provided when the members and the general people access the data bank 21 to have access to specific information, and prevents the general people connected to the data bank 21 from damaging various information stored therein.

4. The Internet-based museum system in accordance with claim 1, wherein the personal information management system 14 digitalizes various information provided from the members, and stores digital information into the data bank 21 by grading the same at the request of the members or based upon judgment of the operator 10.

5. The Internet-based museum system in accordance with claim 1, wherein the information transfer processing system 15 functions to provide various data received from the data bank 21 to the user 30.

6. The Internet-based museum system in accordance with claim 1, wherein the electronic key system 22 is interlocked with the electronic key system 13 of the operator server 11, whereby specific information can be inspected or provided if a pre-inputted password is identified, and whereby specific information can, be inspected or provided if the operator 10, the data bank manger 20 and a user 30 have the same password, wherein the password may be changed by mutual agreement among the operator 10, the data bank manager 20 and the user 30.

7. The Internet-based museum system in accordance with claim 1, wherein the database 23 grades various information digitalized by the personal information management system 14 and the information data input/output device of the operator server 11 and stores graded information.

8. The Internet-based museum system in accordance with claim 1, wherein the information transfer system 24 transfers information extracted from the database 23 at the request of the user 30 or member into the operator server 11.
